(19) United States
(12) Patent Application Publication
(10) Pub. No.: US 2008/0195371 A1
(43) Pub. Date: Aug. 14, 2008

(54) Apparatus and Method to Syncronously Decode a Stenographic Input into Two or More Different Language Streaming Text Outputs

(76) Inventor: ROBERT J. BROWN, TUCSON, AZ (US)

Correspondence Address: DALE F. REGELMAN, QUARLES & BRADY, LLP, ONE SOUTH CHURCH AVENUE AVE, STE. 1700, TUCSON, AZ, 85701-1621, US

(21) Appl. No.: 11/673,517

(22) Filed: Feb. 9, 2007

(51) Int. Cl. G06F 17/28

(52) U.S. Cl. 704/2; 704/E15.012

(57) ABSTRACT

A method is disclosed to synchronously generate from a single stenographic input two or more streaming text outputs each comprising a different language. The method provides a stenographic data stream comprising a plurality of first language-based encoded words, and synchronously forms a first language streaming text output and a second language streaming text output.

### FIELD OF THE INVENTION

This invention relates to an apparatus and method to synchronously decode a single stenographic input into two or more different language streaming text outputs.

### BACKGROUND OF THE INVENTION

Stenographers are able to record dialog extremely quickly by generating a ‘machine shorthand’ or ‘stenographic language’ using a stenograph machine. The language is created by the stenographer striking multiple keys at the same time, a first hand phonetically capturing the beginning of a syllable, while the second hand captures the end. Each stroke creates a ‘line’ of stenographic language, presented as characters on the machine's paper output tape and/or as a sequence of electrical output signals at the machine's output connector. When the output signal is made the input to a computer system, the signal can be decoded into stenographic data and then translated back to the original language that the stenographer is transcribing. When the appropriate software is used, a speech-to-text system can be made where the language is subsequently delivered to a remote viewing location.

Currently, computer software is available to produce text in the language that the stenographic data was recorded in by the stenographer. However, real-time translation and display of stenographic data is limited to a single language. Given that stenography is used in situations such as court hearings, often one or more participants may not speak the language the proceeding is conducted in. Thus, there is a need for a method and system for performing real-time translation of stenographic data into multiple languages simultaneously.

### SUMMARY OF THE INVENTION

Accordingly, the present invention relates to a method for synchronously generating from a single stenographic input two or more streaming text outputs each comprising a different language.

Another aspect of the invention is an article of manufacture comprising a computer readable medium having computer readable program code for performing the method. Additionally, the invention includes a computer program product usable with a programmable computer processor to carry out the method.

The invention also provides a detailed method for synchronously generating from a single stenographic input two or more streaming text outputs each comprising a different language where multiple translation resources are used. These streaming text outputs can be displayed on visual display devices as they are generated. One embodiment of the invention includes a first translation resource that associates stenograph words with one or more words in the recorded language and one or more words in other languages. The first translation resource can be used to form language text streams by replacing each stenograph word with one or more words in the recorded language and one or more words in other languages. An additional aspect of the invention uses a second translation resource that associates two or more language words of the recorded language with phrases in other languages. The corresponding language words in those language text streams can then be replaced with the associated phrase. Further, a third translation resource is provided in another embodiment to associate one or more language words of the recorded language with canonical phrases in the recorded language. The canonical phrases are then used to replace the corresponding language words in the other language text streams. Another aspect of the invention is an article of manufacture comprising a computer readable medium having computer readable program code for performing the mentioned methods. Additionally, the invention includes a computer program product usable with a programmable computer processor to carry out the methods.

### BRIEF DESCRIPTION OF THE DRAWINGS

The invention will be better understood from a reading of the following detailed description taken in conjunction with the drawings in which like reference designators are used to designate like elements, and in which:

FIG. 1A is a flow chart summarizing certain steps of Applicant's method;

FIG. 1B is a flow chart summarizing additional steps of Applicant's method;

FIG. 2 is a flow chart summarizing additional steps of Applicant's method;

FIG. 3 is a flow chart summarizing additional steps of Applicant's method;

FIG. 4 is a flow chart summarizing additional steps of Applicant's method;

FIG. 5 is a flow chart summarizing additional steps of Applicant's method;

FIG. 6 is a flow chart summarizing additional steps of Applicant's method;

FIG. 7 is a flow chart summarizing additional steps of Applicant's method;

FIG. 8A is a block diagram illustrating one embodiment of Applicant's first translation resource;

FIG. 8B is a block diagram illustrating a second embodiment of Applicant's first translation resource;

FIG. 9 is a block diagram illustrating one embodiment of Applicant's apparatus;

FIG. 10 is a block diagram illustrating a second embodiment of Applicant's apparatus;

FIG. 11A is a block diagram illustrating one embodiment of Applicant's second translation resource; and

FIG. 11B is a block diagram illustrating a second embodiment of Applicant's first translation resource.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

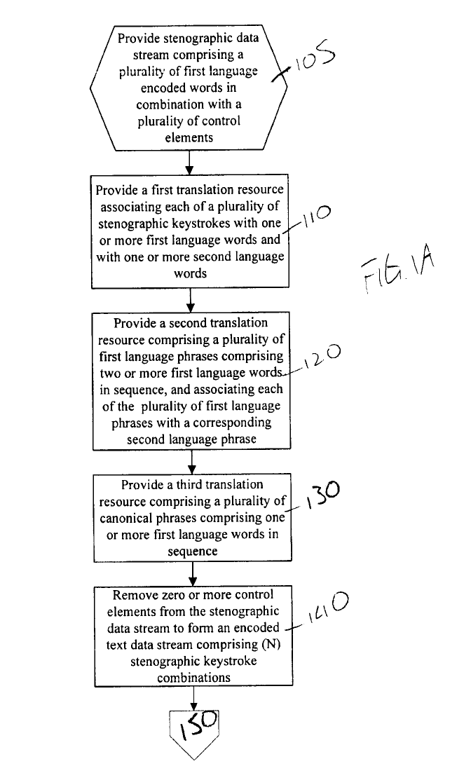

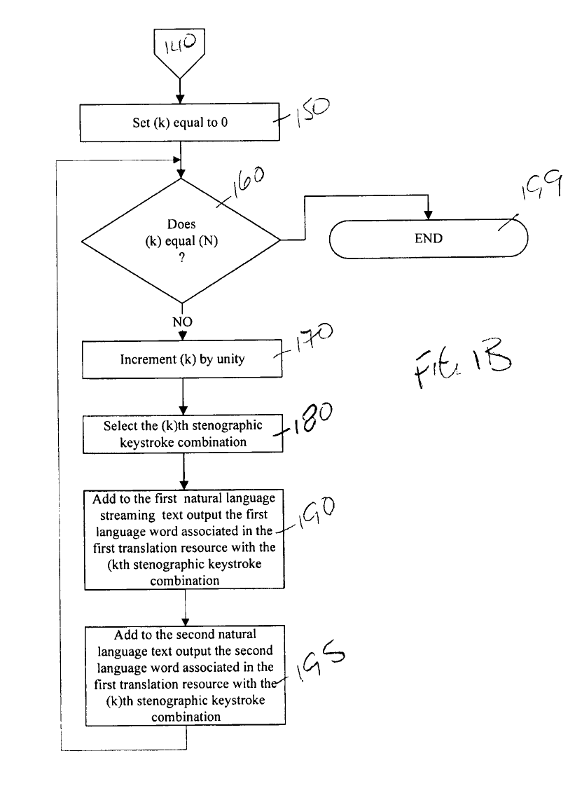

Referring now to FIG. 1, in step 105 the method provides a stenographic data stream comprising a plurality of encoded first language words in combination with a plurality of control elements. In step 110, Applicant's method provides a first translation resource comprising a plurality of stenographic keystroke combinations, wherein each of those stenographic keystroke combinations are associated with a first language word and a second language word.

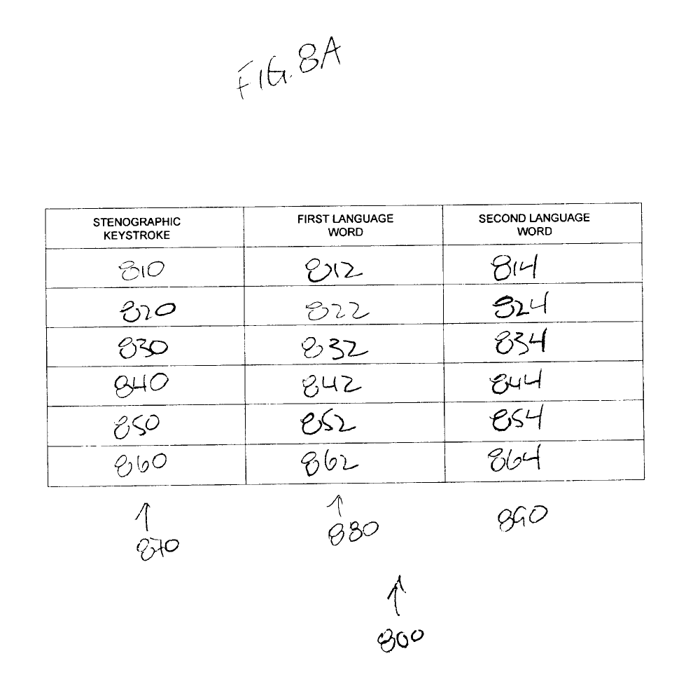

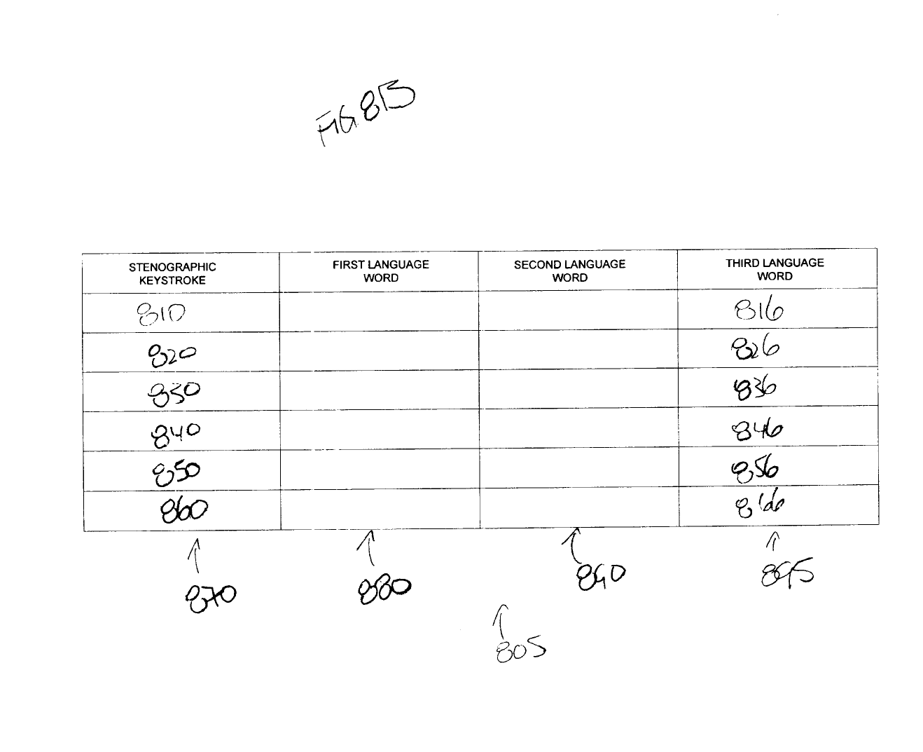

In certain embodiments, the first translation resource comprises a lookup table, a database, or a dictionary. For example and without limitation, lookup table 800 (FIG. 8A) comprises a plurality of stenographic keystroke combinations 870, wherein each of those stenographic keystroke combinations are associated with a first language word 880 and a second language word 890. For example, stenographic keystroke combination 810 is associated with first language words 812 and with second language word 814. Similarly, stenographic keystroke combinations 820, 830, 840, 850 and 860, are associated with first language words 822, 832, 842, 852, and 862, respectively. In addition, stenographic keystroke combinations 820, 830, 840, 850 and 860, are associated with second language words 824, 834, 844, 854, and 864, respectively.

Referring now to FIG. 8B, lookup table 805 comprises a plurality of stenographic keystroke combinations 870, wherein each of those stenographic keystroke combinations are associated with a first language word 880 and a second language word 890, and a third language word 895. For example, stenographic keystroke combination 810 is associated with third language word 816. Similarly, stenographic keystroke combinations 820, 830, 840, 850 and 860, are associated with third language word 826, 836, 846, 856, and 866, respectively.

Applicant's apparatus and method receive a stenographic input and synchronously provide two or more streaming language text outputs. Using lookup table 805, in certain embodiments Applicant's method can receive a stenographic input which encodes first language words and synchronously provide a first streaming text output comprising the first language and a second streaming text output comprising the second language. In other embodiments, Applicant's method can receive a stenographic input which encodes first language words and synchronously provide a first streaming text output comprising the first language and a second streaming text output comprising the third language. In still other embodiments, Applicant's method can receive a stenographic input which encodes first language words and synchronously provide a first streaming text output comprising the first language, a second streaming text output comprising the second language, and a third streaming text output comprising the third language.

In certain embodiments, the original language and each of the output languages utilize what is sometimes referred to as “universal grammar.” Such languages include, without limitation, English, Spanish, Italian, Portuguese, French, and German, wherein any one of those languages may comprise the first, i.e. original, language, or the second language, or the third language.

Universal grammar is a theory of linguistics postulating principles of grammar shared by all languages, thought to be innate to humans. It attempts to explain language acquisition in general, not describe specific languages. This theory does not claim that all human languages have the same grammar, or that all humans are “programmed” with a structure that underlies all surface expressions of each and every specific human language.

Rather, universal grammar proposes a set of rules that would explain how children acquire their language(s), or how they construct valid sentences of their language. The idea can be traced to Roger Bacon's observation that all languages are built upon a common grammar, substantially the same in all languages, even though it may undergo in them accidental variations, and the 13th century speculative grammarians who, following Bacon, postulated universal rules underlying all grammars. The concept of a universal grammar or language was at the core of the 17th century projects for philosophical languages. Later linguists who have influenced this theory include Noam Chomsky, Edward Sapir and Richard Montague.

Referring once again to FIG. 1A, in step 120 the method provides a second translation resource comprising a plurality of first language phrases each comprising two or more first language words in sequence and a plurality of second language phrases each comprising two or more second language words in sequence. Each first language phrase is associated with a second language phrase.

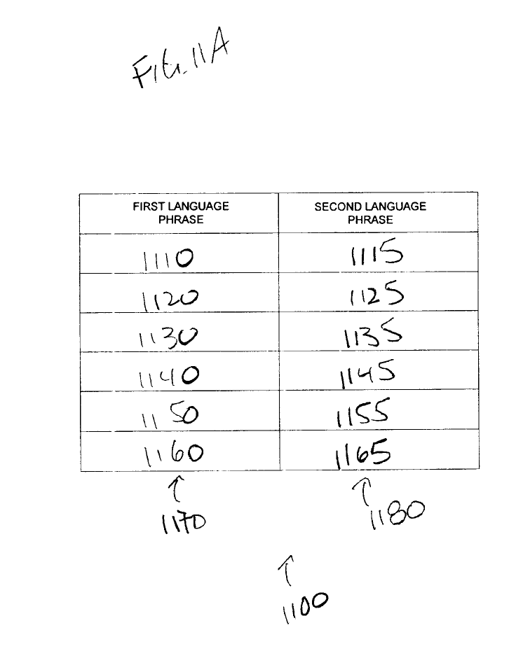

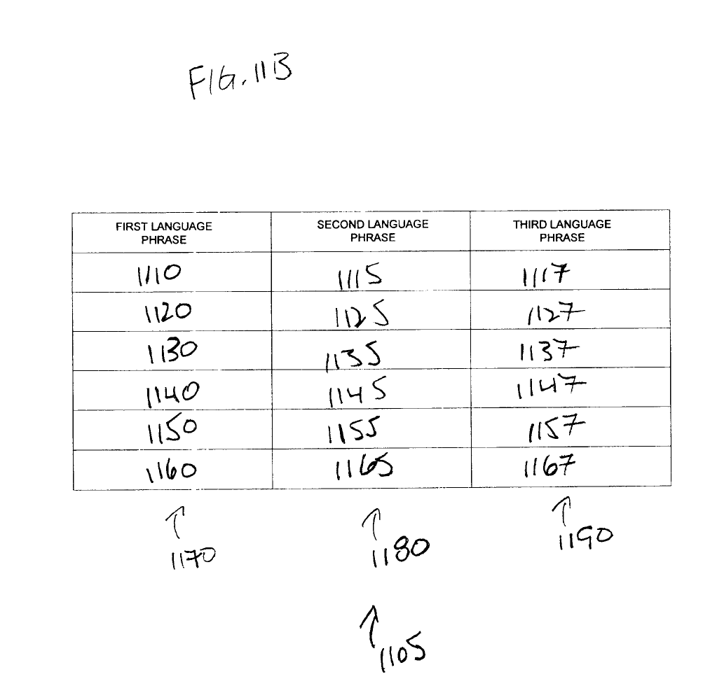

In certain embodiments, the second translation resource comprises a lookup table, a database, or a dictionary. For example and without limitation, second translation resource 1100 (FIG. 11A) comprises a lookup table comprising a plurality of first language phrases 1170, wherein each of those first language phrases comprise two or more first language words in sequence, wherein each first language phrase is associated with a second language phrase 1180, wherein each second language phrase comprises one or more second language words. For example, first language phrase 1110 is associated with second language phrase 1115. Similarly, first language phrases 1120, 1130, 1140, 1150, and 1160, are associated with second language phrases 1125, 1135, 1145, 1155, and 1165, respectively. As an example and without limitation, if the first language comprises English and the second language comprises Spanish, and if first language phrase 1110 comprises “right now,” then the associated second language phrase 1115 comprises “ahora mismo.”

Referring now to FIG. 11B, second translation resource 1105 comprises a lookup table comprising a plurality of first language phrases 1170, wherein each first language phrase is associated with a second language phrase 1180, and wherein each first language phrase is associated with a third language phrase 1190. For example, first language phrase 1110 is associated with third language phrase 1117. Similarly, first language phrases 1120, 1130, 1140, 1150, and 1160, are associated with second language phrases 1127, 1137, 1147, 1157, and 1167, respectively.

Referring once again to FIG. 1A, in step 140 the method removes zero or more control word from the stenographic data stream to form an encoded text data stream comprising (N) stenographic keystroke combinations and a control word stream. The method transitions from step 150 to step 150 (FIG. 1B).

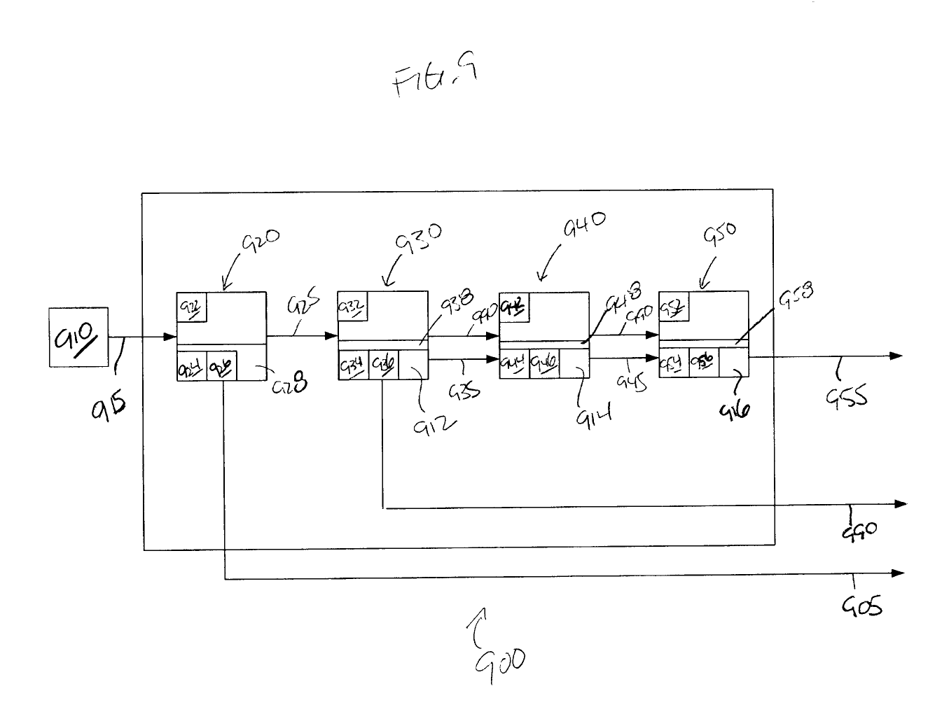

In certain embodiments, Applicant's stenographic translation apparatus comprises a plurality of modules. For example, in the illustrated embodiment of FIG. 9 apparatus 900 comprises first module 920, second module 930, third module 940, and fourth module 950. Stenographic apparatus 910 provides to module 920 a stenographic data stream 915 comprising a plurality of stenographically encoded first language words in combination with zero or more control words. Module 920 removes the zero or more control words from the stenographic data stream 915 to form control word stream 905 and stenographically encoded text stream 925 comprising (N) stenographic stroke combinations.

Module 920 provides that stenographically encoded text stream 925 to Translation Module 930. In continuous process embodiments, module 920 continuously provides stenographically encoded text stream 925 to Translation Module 930 as text stream 925 is formed. In other batch process embodiments, module 920 provides stenographically encoded text stream 925 to Translation Module 930 only after processing the entire stenographic data stream 915.

In the illustrated embodiment of FIG. 9, module 920 comprises processor 922, microcode 924, and computer program code 926, wherein processor 922 utilizes microcode 924 to operate module 920 and computer program code 926 to performed step 140. In certain embodiments computer program code 926 comprises a portion of microcode 924. In certain embodiments, step 140 is performed by processor 922.

Referring now to FIG. 1B, in step 150 the method sets (k) to 0. The variable (k) comprises the current stenographic key stroke combination being examined by Translation Module 930. Referring once again to FIG. 9, in certain embodiments step 150 is performed by Translation Module 930. In the illustrated embodiment of FIG. 9, Translation Module 930 comprises processor 932, memory 928, microcode 934 written to memory 928, and computer program code 936 written to memory 928. Translation Module 930 further comprises first translation resource 912 written to memory 928. Processor 932 utilizes microcode 934 to operate Translation Module 930 and computer program code 936 to perform step 150. In certain embodiments, first translation resource 912 comprises a portion of computer program code 936. In certain embodiments computer program code 936 comprises a portion of microcode 934. In certain embodiments, step 150 is performed by processor 932.

In step 160, the method determines if (k) equals (N), i.e. determines if Translation Module 930 has examined each of the stenographic keystroke combinations comprising the stenographic data stream 915. If the method determines in step 170 that (k) equals (N), then the steps of the method performed by Translation Module 930 have been completed, and the method transitions from step 160 to step 195 wherein Translation Module 930 stops processing stenographically encoded text stream 925.

If the method determines in step 160 that (k) does not equal (N), then the method transitions from step 160 to step 170 wherein the method increments (k) by unity. In certain embodiments, step 170 is performed by Translation Module 930. In certain embodiments, step 170 is performed by processor 932.

In step 180, the method selects the (k)th stenographic keystroke combination. In certain embodiments, step 180 is performed by Translation Module 930. In certain embodiments, step 180 is performed by processor 932.

In step 190, the method adds to the first language streaming text output 990 the first language word associated in the first translation resource with the (k)th stenographic stroke combination. In certain embodiments, step 190 is performed by Translation Module 930. In certain embodiments, step 190 is performed by processor 932.

In step 195, the method adds to the second language streaming text output 935 the second language word associated in the first translation resource with the (k)th stenographic stroke combination. In certain embodiments, step 195 is performed by Translation Module 930. In certain embodiments, step 195 is performed by processor 932.

The first language streaming text output 990 comprises an output from apparatus 900. In continuous process embodiments, Translation Module 930 continuously provides first language streaming text output 990 to TransPhraselet Module 940 as that streaming text is formed. In batch process embodiments, Translation Module 930 provides first language streaming text output 990 to TransPhraselet Module 940 only after processing the entire stenographic stenographically encoded text stream 925.

Translation Module 930 further provides second language streaming text output 935 to TransPhraselet Module 940 (FIG. 9). In continuous process embodiments, Translation Module 930 continuously provides second language streaming text output 935 to TransPhraselet Module 940 as that streaming text is formed. In batch process embodiments, Translation Module 930 provides second language streaming text output 935 to TransPhraselet Module 940 only after processing the entire stenographic stenographically encoded text stream 925.

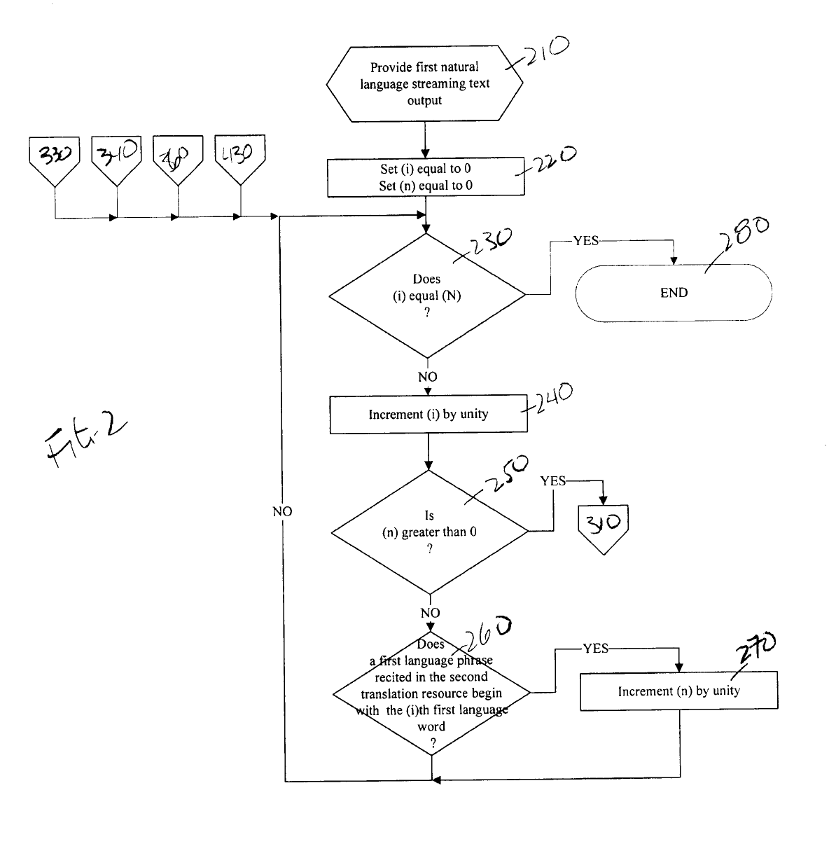

FIGS. 2, 3, and 4, summarize the steps of the method performed by TransPhraselet Module 940. Referring now to FIG. 2, in step 210 TransPhraselet module 940 receives a first language streaming text output 990, and a second language streaming text output 935, from Translation Module 930. In the illustrated embodiment of FIG. 9, TransPhraselet Module 940 comprises processor 942, memory 948, microcode 944 written to memory 948, and computer program code 946 written to memory 948. In the illustrated embodiment of FIG. 9, TransPhraselet Module 940 further comprises second translation resource 914. Processor 942 utilizes microcode 944 to operate TransPhraselet Module 940 and computer program code 946 to performed the steps recited in FIGS. 2, 3, and 4. In certain embodiments, second translation resource 914 comprises a portion of computer program code 946. In certain embodiments computer program code 946 comprises a portion of microcode 944.

In step 220, the method sets (i) to 0 and (n) to 0. The variable (i) represents the word in the first language streaming text output being examined. The variable (n) represents the number of words comprising a first language phrase, wherein that first language phrase is recited in the second translation resource. In certain embodiments, step 220 is performed by TransPhraselet Module 940. In certain embodiments, step 220 is performed by processor 942.

In step 230, the method determines if (i) equals (N), i.e. determines if TransPhraselet Module 940 has examined each of the words in the first language streaming text. In certain embodiments, step 230 is performed by TransPhraselet Module 940. In certain embodiments, step 230 is performed by processor 942.

If the method determines in step 230 that (i) equals (N), then the steps of the method performed by TransPhraselet Module 940 have been completed, and the method transitions from step 230 to step 290 wherein TransPhraselet Module 940 stops processing the first language streaming text 935.

If the method determines in step 230 that (i) does not equal (N), then the method transitions from step 230 to step 240 wherein the method increments (i) by unity. In certain embodiments, step 240 is performed by TransPhraselet Module 940. In certain embodiments, step 240 is performed by processor 942.

In step 250, the method determines if (n) is greater than 0, i.e. determines if TransPhraselet Module 940 has identified a potential first language phrase wherein (n) indicates the number of first language words disposed in that candidate first language phrase. In certain embodiments, step 250 is performed by TransPhraselet Module 940. In certain embodiments, step 250 is performed by processor 942.

If the method determines in step 250 that (n) is 0, then the method transitions from step 250 to step 260 wherein the method determines if a first language phrase recited in the second translation resource begins with the (i)th first language word. In certain embodiments, step 260 is performed by TransPhraselet Module 940. In certain embodiments, step 260 is performed by processor 942.

If the method determines in step 260 that a first language phrase recited in the second translation resource begins with the (i)th first language word, then the method transitions from step 260 to step 270 wherein the method increments (n) by unity. The method transitions from step 270 to step 230 and continues as described herein. In certain embodiments, step 270 is performed by TransPhraselet Module 940. In certain embodiments, step 270 is performed by processor 942.

If the method determines in step 260 that no first language phrase recited in the second translation resource does begins with the (i)th first language word, then the method transitions from step 260 to step 230 and continues as described herein.

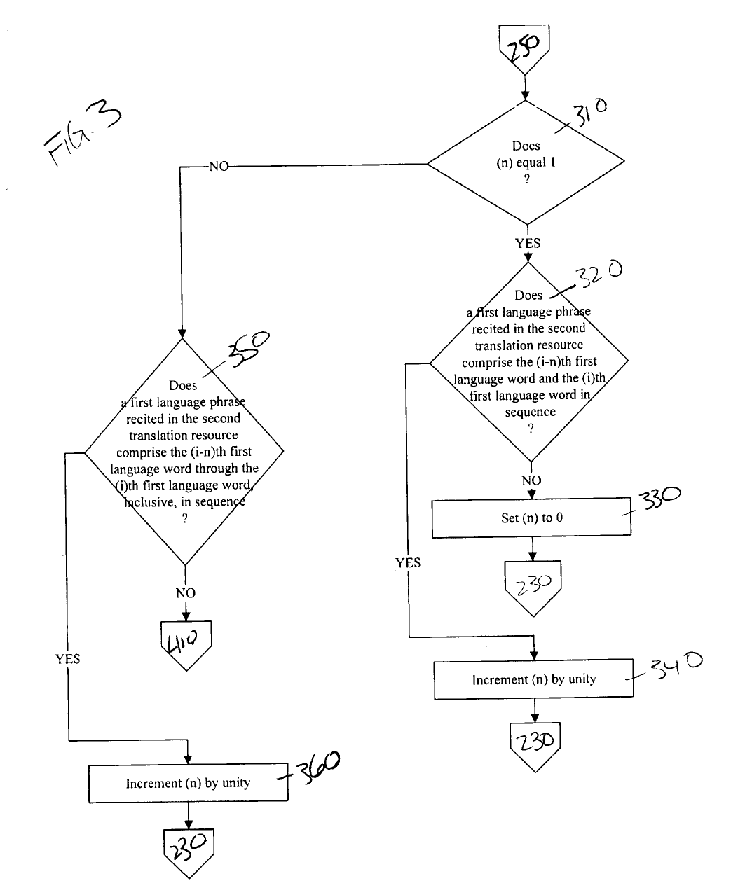

If the method determines in step 250 that (n) is greater than 0, then the method transitions from step 250 to step 310 (FIG. 3). Referring now to FIG. 3, in step 310 the method determines if (n) equals 1. In certain embodiments, step 310 is performed by TransPhraselet Module 940. In certain embodiments, step 310 is performed by processor 942.

If the method determines in step 310 that (n) equals 1, then the method transitions from step 310 to step 320 wherein the method determines if a first language phrase recited in the second translation resource comprises the (i−n)th first language word and the (i)th first language word in sequence. In certain embodiments, step 320 is performed by TransPhraselet Module 940. In certain embodiments, step 320 is performed by processor 942.

If Applicant's method determines in step 320 that no first language phrase recited in the second translation resource comprises the (i−n)th first language word and the (i)th first language word in sequence, then the method transitions from step 320 to step 330 wherein the method sets (n) equal to 0. In certain embodiments, step 330 is performed by TransPhraselet Module 940. In certain embodiments, step 330 is performed by processor 942. The method transitions from step 330 to step 230 and continues as described herein.

If the method determines in step 310 that (n) does not equal 1, then the method transitions from step 310 to step 350 wherein the method determines if a first language phrase recited in the second translation resource comprises the (i−n)th first language word through the (i)th first language word, inclusive and in sequence. In certain embodiments, step 350 is performed by TransPhraselet Module 940. In certain embodiments, step 350 is performed by processor 942.

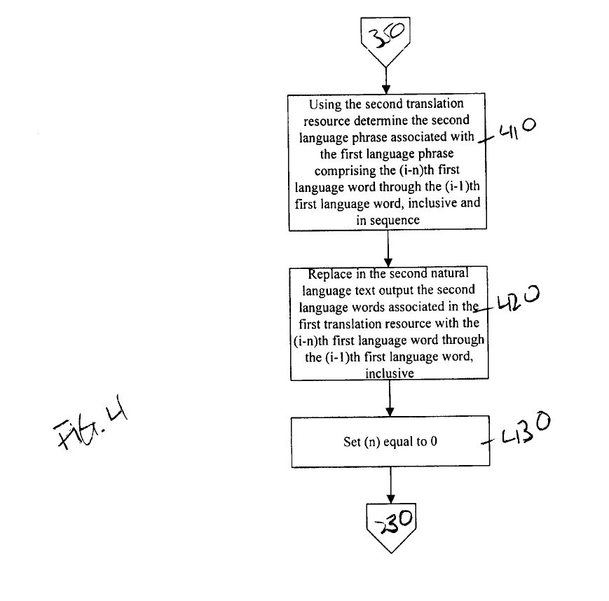

If the method determines in step 350 that a first language phrase recited in the second translation resource comprises the (i−n)th first language word through the (i)th first language word, inclusive and in sequence, then the method transitions from step 350 to step 360 wherein the method increments (n) by unity. In certain embodiments, step 360 is performed by TransPhraselet Module 940. In certain embodiments, step 360 is performed by processor 942. The method transitions from step 360 to step 230 and continues as described herein. If the method determines in step 350 that no first language phrase recited in the second translation resource comprises the (i−n)th first language word through the (i)th first language word, inclusive and in sequence, then the method transitions from step 350 to step 410 (FIG. 4).

Referring now to FIG. 4, in step 410 the method determines the second language phrase associated in the second translation resource with the first language phrase comprising the (i−n)th first language word through the (i−1)th first language word, inclusive and in sequence. In certain embodiments, step 410 is performed by TransPhraselet Module 940. In certain embodiments, step 410 is performed by processor 942.

In step 420, the method replaces in the second language streaming text 935 the second language words associated in the first translation resource with the (i−n)th first word through the (i−1)th first language word, inclusive, with the second language phrase of step 410. In certain embodiments, step 420 is performed by TransPhraselet Module 940. In certain embodiments, step 420 is performed by processor 942. The method transitions from step 430 to step 230 and continues as described herein.

TransPhraselet Module 940 provides second language streaming output 945 to Transposition Module 950. In continuous process embodiments, TransPhraselet Module 940 continuously provides second language streaming output 945 to Transposition Module 950 as second language streaming output 945 is formed. In batch process embodiments, TransPhraselet Module provides second language streaming output 945 to Translation Module 930 only after processing the entire second language streaming output 935.

There are certain designations, i.e. canonical phrases, that should not be translated into the second language. As an example and without limitation, certain geographical locations should be recited in the second language streaming text output as recited in the first language streaming text output. For example and without limitation, if the geographical designation “New York” is recited in a first language streaming text output, that designation should not be translated into “Neuvo York” in a second language streaming text output wherein that second language comprises Spanish.

Applicant's third translation resource recites such canonical phrases. Applicant's Transposition Module 950 examines the first language streaming output 990 to determine if that first language streaming text output comprises any canonical phrases recited in the third translation resource.

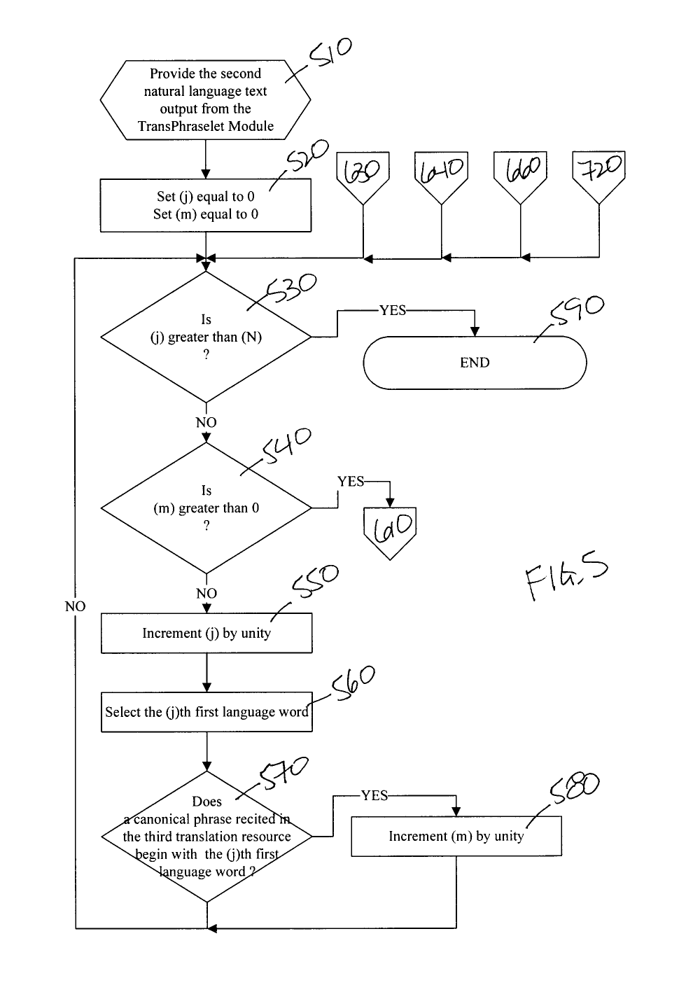

Referring now to FIG. 5, in step 510 Transposition Module 950 receives a first language streaming text output 990, and a second language streaming text output 945, from TransPhraselet Module 940. In the illustrated embodiment of FIG. 9, Transposition Module 950 comprises processor 952, memory 958, microcode 954 written to memory 958, and computer program code 956 written to memory 958. In the illustrated embodiment of FIG. 9, Transposition Module 950 further comprises third translation resource 916. Processor 952 utilizes microcode 954 to operate Transposition Module 950 and computer program code 956 to performed the steps recited in FIGS. 5, 6, and 7. In certain embodiments, third translation resource 916 comprises a portion of computer program code 956. In certain embodiments computer program code 956 comprises a portion of microcode 954.

In step 520, the method sets (j) to 0 and (m) to 0. The variable (j) represents the word in the first language streaming text output being examined. The variable (m) represents the number of words comprising a canonical phrase recited in the third translation resource. In certain embodiments, step 520 is performed by Transposition Module 950. In certain embodiments, step 520 is performed by processor 952.

In step 530, the method determines if (j) equals (N), i.e. determines if Transposition Module 950 has examined each of the words in the first language streaming text. In certain embodiments, step 530 is performed by Transposition Module 950. In certain embodiments, step 530 is performed by processor 542.

If the method determines in step 530 that (j) equals (N), then the steps of the method performed by Transposition Module 950 have been completed, and the method transitions from step 530 to step 590 wherein Transposition Module 950 stops generating the second language streaming text 955.

If the method determines in step 530 that (j) does not equal (N), then the method transitions from step 530 to step 540 wherein the method determines if (m) is greater than 0, i.e. determines if Transposition Module 950 has identified a potential canonical phrase wherein (m) indicates the number of first language words disposed in that candidate canonical phrase. In certain embodiments, step 540 is performed by Transposition Module 950. In certain embodiments, step 540 is performed by processor 942.

If the method determines in step 540 that (m) is 0, then the method transitions from step 540 to step 550 wherein the method increments (j) by unity. In certain embodiments, step 550 is performed by Transposition Module 950. In certain embodiments, step 550 is performed by processor 552.

In step 560, the method selects the (j)th first language word in the first language streaming text output. In certain embodiments, step 560 is performed by Transposition Module 950. In certain embodiments, step 560 is performed by processor 552.

In step 570, the method determines if a canonical phrase recited in the third translation resource begins with the (j)th first language word. In certain embodiments, step 570 is performed by Transposition Module 950. In certain embodiments, step 570 is performed by processor 952.

If the method determines in step 570 that a canonical phrase recited in the third translation resource begins with the (j)th first language word, then the method transitions from step 570 to step 580 wherein the method increments (m) by unity. The method transitions from step 580 to step 530 and continues as described herein. In certain embodiments, step 580 is performed by Transposition Module 950. In certain embodiments, step 580 is performed by processor 952.

If the method determines in step 570 that no canonical phrase recited in the third translation resource begins with the (j)th first language word, then the method transitions from step 570 to step 530 and continues as described herein.

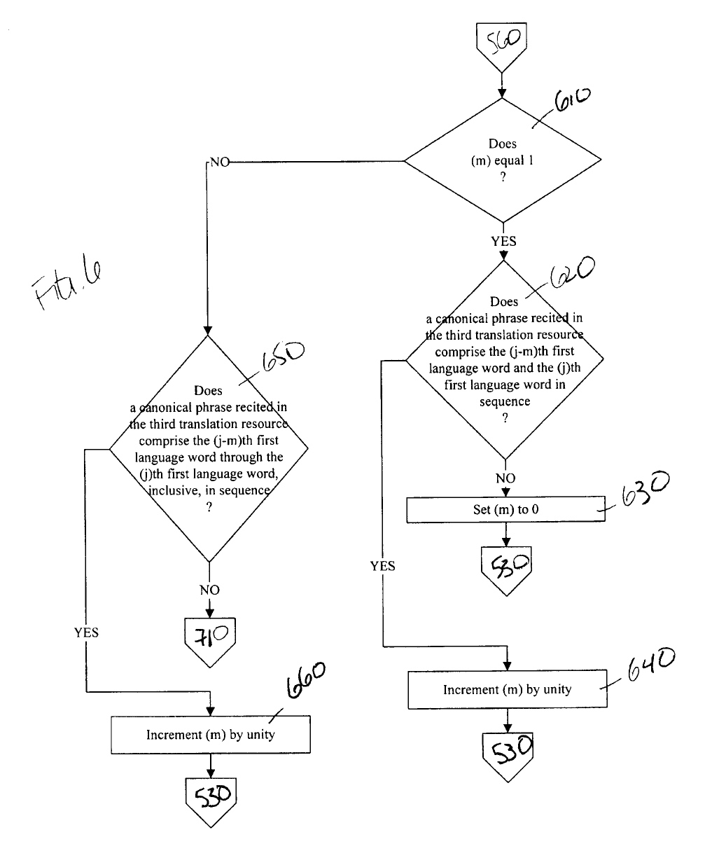

If the method determines in step 530 that (m) is greater than 0, then the method transitions from step 530 to step 610 (FIG. 6). Referring now to FIG. 6, in step 610 the method determines if (m) equals 1. In certain embodiments, step 610 is performed by Transposition Module 950. In certain embodiments, step 610 is performed by processor 952.

If the method determines in step 610 that (m) equals 1, then the method transitions from step 610 to step 620 wherein the method determines if a canonical phrase recited in the third translation resource comprises the (j−n)th first language word and the (j)th first language word in sequence. In certain embodiments, step 620 is performed by Transposition Module 950. In certain embodiments, step 620 is performed by processor 952.

If Applicant's method determines in step 620 that no first language phrase recited in the second translation resource comprises the (j−n)th first language word and the (j)th first language word in sequence, then the method transitions from step 620 to step 630 wherein the method sets (m) equal to 0. In certain embodiments, step 630 is performed by Transposition Module 950. In certain embodiments, step 630 is performed by processor 952. The method transitions from step 630 to step 530 and continues as described herein.

If the method determines in step 610 that (m) does not equal 1, then the method transitions from step 610 to step 650 wherein the method determines if a canonical phrase recited in the third translation resource comprises the (j−n)th first language word through the (j)th first language word, inclusive and in sequence. In certain embodiments, step 650 is performed by Transposition Module 950. In certain embodiments, step 650 is performed by processor 952.

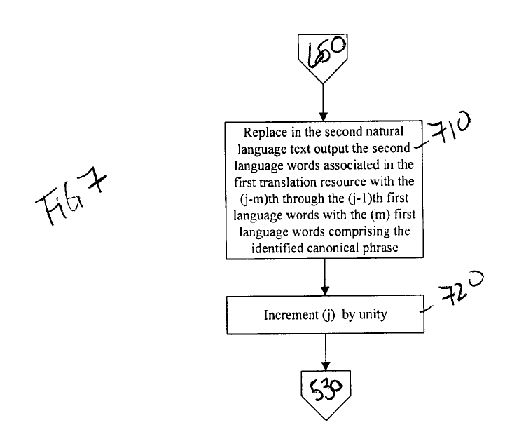

If the method determines in step 650 that a canonical phrase recited in the third translation resource comprises the (j−n)th first language word through the (j)th first language word, inclusive and in sequence, then the method transitions from step 650 to step 660 wherein the method increments (m) by unity. In certain embodiments, step 660 is performed by Transposition Module 950. In certain embodiments, step 660 is performed by processor 952. The method transitions from step 660 to step 530 and continues as described herein. If the method determines in step 650 that no canonical phrase recited in the third translation resource comprises the (j−n)th first language word through the (j)th first language word, inclusive and in sequence, then the method transitions from step 650 to step 710 (FIG. 7).

Referring now to FIG. 7, in step 710 the method replaces in the second language streaming text 945 the second language words associated in the first translation resource with (i−n)th first word through the (i−1)th first language word, inclusive and in sequence, with the canonical phrase comprising the (i−n)th first word through the (i−1)th first language word, inclusive and in sequence. In certain embodiments, step 710 is performed by Transposition Module 950. In certain embodiments, step 710 is performed by processor 952.

In step 720, the method sets (m) equal to 0 and increments (j) by unity. In certain embodiments, step 720 is performed by Transposition Module 950. In certain embodiments, step 720 is performed by processor 952. The method transitions from step 720 to step 530 and continues as described herein.

### OTHER EMBODIMENTS

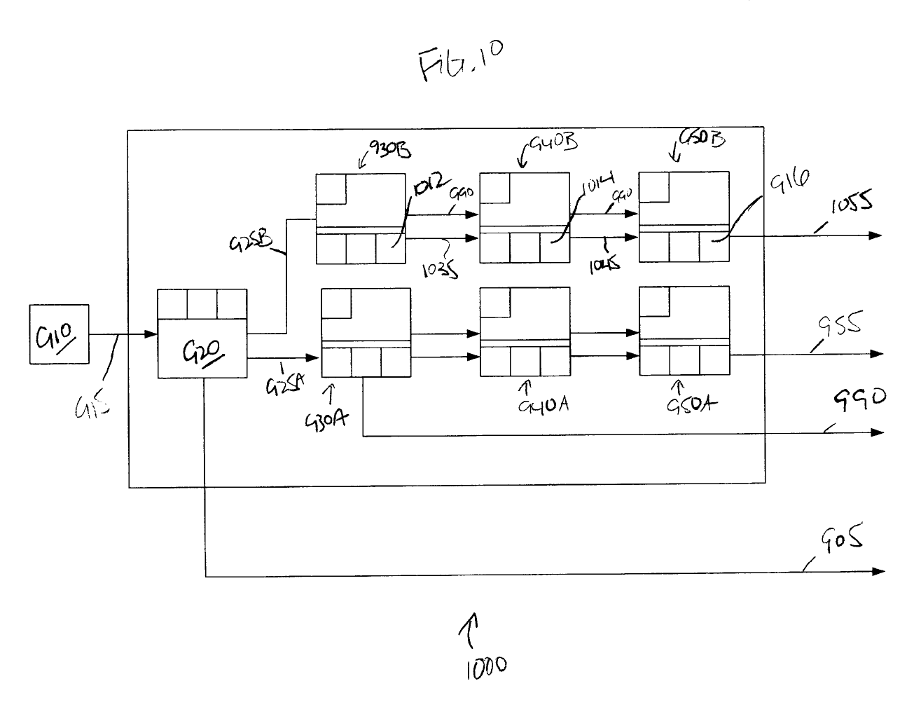

In certain embodiments, Applicant's apparatus provides a first language streaming text, a second language streaming text, and a third language streaming text. Referring now to FIG. 10, in certain embodiments Applicant's apparatus comprises apparatus 1000 which comprises a first Translation Module 930A and a second Translation Module 930B, a first TransPhraselet Module 940A and a second TransPhraselet Module 940B, and a first Transposition Module 950A and a second Transposition Module 950B. Module 920 provides stenographically encoded text stream 925A to first Translation Module 930A and stenographically encoded text stream 925B to second Translation Module 930B.

Second Translation Module 930B utilizes the steps of FIGS. 1A and 1B in combination with first translation resource 1012 associating each of a plurality of stenographic keystroke combinations with a first language word and a third language word to form third language streaming text output 1035. Second Translation Module 930B provides that third language streaming text output 1035 to Second TransPhraselet Module 940B.

Second TransPhraselet Module 940B utilizes the steps of FIGS. 2, 3, and 4, in combination with second translation resource 1014 associating each of a plurality of first language phrases with a corresponding third language phrase, to form third language streaming text output 1045, and provides that third language streaming text output 1045 to Second Transposition Module 950B.

Second Transposition Module 950B utilizes the steps of FIGS. 5, 6, and 7, in combination with third translation resource 916, to form third language streaming text output 1055 which is output from apparatus 1000.

In certain embodiments, individual steps recited in FIGS. 1A, 1B, 2, 3, 4, 5, 6, and 7, may be combined, eliminated, or reordered.

In certain embodiments, Applicants' invention includes instructions residing memory 928 (FIG. 9), and/or memory 938 (FIG. 9), and/or memory 948 (FIG. 9), and/or memory 958 (FIG. 9), wherein those instructions are executed by a processor, such as processor 922 (FIG. 9), and/or processor 932 (FIG. 9), and/or processor 942 (FIG. 9), and/or processor 952 (FIG. 9), to perform step 140 recited in FIG. 1A, and/or one or more of steps 150, 160, 170, 180, 190, and/or 195, recited in FIG. 1B, and/or one or more of steps 210, 220, 230, 240, 250, 260, and/or 270, recited in FIG. 2, and/or one or more of steps 310, 320, 330, 340, 350, and/or 360, recited in FIG. 3, and/or one or more of steps 410, 420, and/or 430, recited in FIG. 4, and/or one or more of steps 510, 520, 530, 540, 550, 560, 570, and/or 580, recited in FIG. 5, and/or one or more of steps 610, 620, 630, 640, 650, and/or 660, recited in FIG. 6, and/or one or more of steps 710 and/or 720, recited in FIG. 7.

In other embodiments, Applicants' invention includes instructions residing in any other computer program product, where those instructions are executed by a computer external to, or internal to, system 600, to perform step 140 recited in FIG. 1A, and/or one or more of steps 150, 160, 170, 180, 190, and/or 195, recited in FIG. 1B, and/or one or more of steps 210, 220, 230, 240, 250, 260, and/or 270, recited in FIG. 2, and/or one or more of steps 310, 320, 330, 340, 350, and/or 360, recited in FIG. 3, and/or one or more of steps 410, 420, and/or 430, recited in FIG. 4, and/or one or more of steps 510, 520, 530, 540, 550, 560, 570, and/or 580, recited in FIG. 5, and/or one or more of steps 610, 620, 630, 640, 650, and/or 660, recited in FIG. 6, and/or one or more of steps 710 and/or 720, recited in FIG. 7.

In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

While the preferred embodiments of the present invention have been illustrated in detail, it should be apparent that modifications and adaptations to those embodiments may occur to one skilled in the art without departing from the scope of the present invention as set forth in the following claims.

I claim:

1. A method to synchronously generate from a single stenographic input two or more streaming text outputs each comprising a different language, comprising the steps of:
providing a stenographic data stream comprising a plurality of first language-based encoded words;
synchronously forming a first language streaming text output and a second language streaming text output.

2. The method of claim 1, wherein said stenographic data stream further comprises a plurality of control elements, said method further comprising the steps of:
forming an encoded text data stream by removing zero or more control elements from said stenographic data stream;
decoding said encoded text data stream to form said first language streaming text output and said second language streaming text output;

3. The method of claim 2, wherein said encoded text keystroke combination data stream comprises (N) stenographic keystroke combinations, wherein (N) is greater than 1, and wherein said decoding step comprises the steps of:
providing a first translation resource comprising a plurality of stenographic keystroke combinations, wherein said first translation resource associates each of said plurality of stenographic keystroke combinations with a first language word and with a second language word;
selecting the (k)th stenographic keystroke combination, wherein (k) is greater than or equal to 1 and less than or equal to (N);
adding to said first language streaming text output a first language word associated by said first translation resource with the (k)th stenographic keystroke combination;
adding to said first language streaming text output a second language word associated by said first translation resource with the (k)th stenographic keystroke combination.

4. The method of claim 3, further comprising the steps of:
providing a second translation resource comprising a plurality of first language phrases, each first language phrase comprising two or more first language words in sequence, wherein said second translation resource associates each of said plurality of first-language phrases with a second language phrase;
determining if said first language streaming text output comprises a first language phrase recited in said second translation resource;
operative if said first language streaming text output comprises a first language phrase recited in said second translation resource, determining the second language phrase associated in said second translation resource with said first language phrase;
incorporating said associated second language phrase into said second language streaming text output.

5. The method of claim 4, further comprising the steps of:
providing a third translation resource comprising a plurality of canonical phrases, wherein each of said canonical phrases comprises one or more first language words;
determining if said first language streaming text output comprises a canonical phrase recited in said third translation resource;
operative if said first language streaming text output comprises a canonical phrase recited in said third translation resource, incorporating said canonical phrase into said second language streaming text output.

6. An article of manufacture comprising a computer readable medium having computer readable program code disposed therein to synchronously generate from a single stenographic input two or more streaming text outputs each comprising a different language, the computer readable program code comprising a series of computer readable program steps to effect:
receiving a stenographic data stream comprising a plurality of first language-based encoded words;
synchronously forming a first language streaming text output and a second language streaming text output.

7. The article of manufacture of claim 6, wherein said stenographic data stream further comprises a plurality of control elements, said computer readable program code further comprising a series of computer readable program steps to effect:
forming an encoded text keystroke combination stream by removing zero or more control elements from a portion of said stenographic data stream;
decoding said encoded text data stream to form said first language streaming text output and said second language streaming text output;

8. The article of manufacture of claim 7, wherein said encoded text data stream comprises (N) stenographic keystroke combinations, further comprising a first translation resource comprising a plurality of stenographic keystroke combinations, wherein said first translation resource associates each of said plurality of stenographic keystroke combinations with a first language word and with a second language word, said computer readable program code to decode said encoded text keystroke combination stream further comprising a series of computer readable program steps to effect:
selecting the (k)th stenographic keystroke combination disposed in said encoded text data stream, wherein (k) is greater than or equal to 1 and less than or equal to (N);
forming said first language streaming text output by adding a first language word associated by said first translation resource with the (k)th stenographic keystroke combination;
forming said second language streaming text output by adding a second language word associated by said first translation resource with the (k)th stenographic keystroke combination.

9. The article of manufacture of claim 7, further comprising a second translation resource comprising a plurality of first language phrases, each first language phrase comprising two or more first language words in sequence, wherein said second translation resource associates each of said plurality of first-language phrases with a second language phrase, said computer readable program code to decode said encoded text keystroke combination stream further comprising a series of computer readable program steps to effect:
determining if said first language streaming text output comprises a first language phrase recited in said second translation resource;
operative if said first language streaming text output comprises a first language phrase recited in said second translation resource, determining the second language phrase associated in said second translation resource with said first language phrase;
incorporating said associated second language phrase into said second language streaming text output.

10. The article of manufacture of claim 7, further comprising a third translation resource comprising a plurality of canonical phrases, wherein each of said canonical phrases comprises one or more first language words, said computer readable program code to decode said encoded text keystroke combination stream further comprising a series of computer readable program steps to effect:
determining if said first language streaming text output comprises a canonical phrase recited in said third translation resource;
operative if said first language streaming text output comprises a canonical phrase recited in said third translation resource, incorporating said canonical phrase into said second language streaming text output.

11. A computer program product encoded in an information storage medium wherein said computer program product is usable with a programmable computer processor to synchronously generate from a single stenographic input two or more streaming text outputs each comprising a different language, comprising:
computer readable program code which causes said programmable computer processor to receive a stenographic data stream comprising a plurality of first language-based encoded words;
computer readable program code which causes said programmable computer processor to synchronously form a first language streaming text output and a second language streaming text output.

12. The computer program product of claim 11, wherein said stenographic data stream further comprises a plurality of control elements, further comprising:
computer readable program code which causes said programmable computer processor to form an encoded text keystroke combination stream by removing zero or more control elements from a portion of said stenographic data stream;
computer readable program code which causes said programmable computer processor to decode said encoded text keystroke combination stream to form said first language streaming text output and said second language streaming text output;

13. The computer program product of claim 12, wherein said encoded text data stream comprises (N) stenographic keystroke combinations, further comprising a first translation resource comprising a plurality of stenographic keystroke combinations, wherein said first translation resource associates each of said plurality of stenographic keystroke combinations with a first language word and with a second language word, said computer readable program code to decode said encoded text keystroke combination stream further comprising:
computer readable program code which causes said programmable computer processor to select the (k)th stenographic keystroke combination disposed in said encoded text data stream, wherein (k) is greater than or equal to 1 and less than or equal to (N);
computer readable program code which causes said programmable computer processor to form said first language streaming text output by adding a first language word associated by said first translation resource with the (k)th stenographic keystroke combination;
computer readable program code which causes said programmable computer processor to form said first language streaming text output by adding a second language word associated by said first translation resource with the (k)th stenographic keystroke combination.

14. The computer program product of claim 13, further comprising a second translation resource comprising a plurality of first language phrases, each first language phrase comprising two or more first language words in sequence, wherein said second translation resource associates each of said plurality of first-language phrases with a second language phrase, said computer readable program code to decode said encoded text keystroke combination stream further comprising:
computer readable program code which causes said programmable computer processor to determine if said first language streaming text output comprises a first language phrase recited in said second translation resource;
computer readable program code which, if said first language streaming text output comprises a first language phrase recited in said second translation resource, causes said programmable computer processor to determine the second language phrase associated in said second translation resource with said first language phrase;
computer readable program code which causes said programmable computer processor to incorporate said associated second language phrase into said second language streaming text output.

15. The computer program product of claim 13, further comprising a third translation resource comprising a plurality of canonical phrases, wherein each of said canonical phrases comprises one or more first language words, said computer readable program code to decode said encoded text keystroke combination stream further comprising:
computer readable program code which causes said programmable computer processor to determine if said first language streaming text output comprises a canonical phrase recited in said third translation resource;
computer readable program code which, if said first language streaming text output comprises a canonical phrase recited in said third translation resource, causes said programmable computer processor to incorporate said canonical phrase into said second language streaming text output.

16. An apparatus to synchronously generate from a single stenographic input two or more streaming text outputs each comprising a different language, comprising:
a first module;
a second module in communication with said first module and in communication with a first translation resource comprising a plurality of stenographic keystroke combinations, wherein said first translation resource associates each of said plurality of stenographic keystroke combinations with a first language word and with a second language word; and
a third module in communication with said second module and in communication with a second translation resource comprising a plurality of first language phrases, each first language phrase comprising two or more first language words in sequence, wherein said second translation resource associates each of said plurality of first-language phrases with a second language phrase;
a fourth module in communication with said third module and in communication with a third translation resource comprising a plurality of canonical phrases, each canonical phrase comprising one or more first language words in sequence.

17. The apparatus of claim 16, wherein:
said first module comprises a first processor;
said first processor performs the steps of:
receiving a stenographic data stream;
forming an encoded text data stream comprises (N) stenographic keystroke combinations by removing zero or more control elements from said stenographic data stream, wherein (N) is greater than or equal to 1.

18. The apparatus of claim 17, wherein:
said second module comprises a second processor;
said second processor performs the steps of:
receiving said encoded text data stream;
selecting the (k)th stenographic keystroke combination disposed in said encoded text data stream, wherein (k) is greater than or equal to 1 and less than or equal to (N);
forming said first language streaming text output by adding a first language word associated by said first translation resource with the (k)th stenographic keystroke combination;
forming said second language streaming text output by adding a second language word associated by said first translation resource with the (k)th stenographic keystroke combination.

19. The apparatus of claim 18, wherein:
said third module comprises a third processor;
said third processor performs the steps of:
determining if said first language streaming text output comprises a first language phrase recited in said second translation resource;
operative if said first language streaming text output comprises a first language phrase recited in said second translation resource, determining the second language phrase associated in said second translation resource with said first language phrase;
incorporating said associated second language phrase into said second language streaming text output.

20. The apparatus of claim 19, wherein:
said fourth module comprises a fourth processor;
said fourth processor performs the steps of:
determining if said first language streaming text output comprises a canonical phrase recited in said third translation resource;
operative if said first language streaming text output comprises a canonical phrase recited in said third translation resource, incorporating said canonical phrase into said second language streaming text output.
